(19) United States
(12) Patent Application Publication
(10) Pub. No.: US 2013/0243198 A1
(43) Pub. Date: Sep. 19, 2013

(54) METHOD FOR REDUCING NOISE INCLUDED IN A STEREO SIGNAL, STEREO SIGNAL PROCESSING DEVICE AND FM RECEIVER USING THE METHOD

(71) Applicant: Herman Wouter Van Rumpt, Hertogenbosch (NL)

(72) Inventor: Herman Wouter Van Rumpt, Hertogenbosch (NL)

(73) Assignee: SEMICONDUCTOR IDEAS TO THE MARKET (ITOM), BREDA (NL)

(21) Appl. No.: 13/883,341

(22) PCT Filed: Nov. 4, 2011
(86) PCT No.: PCT/EP11/05571

§ 371 Date: May 23, 2013

(30) Foreign Application Priority Data
Nov. 5, 2010 (EP) 10014320.5

(51) Int. Cl. H04H 40/72

(52) U.S. Cl. CPC H04H 40/72
USPC 381/13

(57) ABSTRACT

Method for reducing noise included in a stereo reproduction signal derived from a stereo input signal characterized by the steps of: *varying stereo channel separation of said stereo reproduction signal with frequency within the frequency range of the stereo input signal in accordance with the frequency response of a filter selectivity located around a center frequency to obtain a stereo channel separation peak value at said center frequency; *at a continuing increase of said noise, decreasing the bandwidth of said filter selectivity to a pre-determined non-zero bandwidth while maintaining the channel separation within the bandwidth of said filter selectivity substantially at said channel separation peak value.

The present invention relates to a method for reducing noise included in a stereo reproduction signal derived from a stereo input signal, to a stereo signal processing device working according to said method, and an FM receiver comprising such stereo signal processing device.

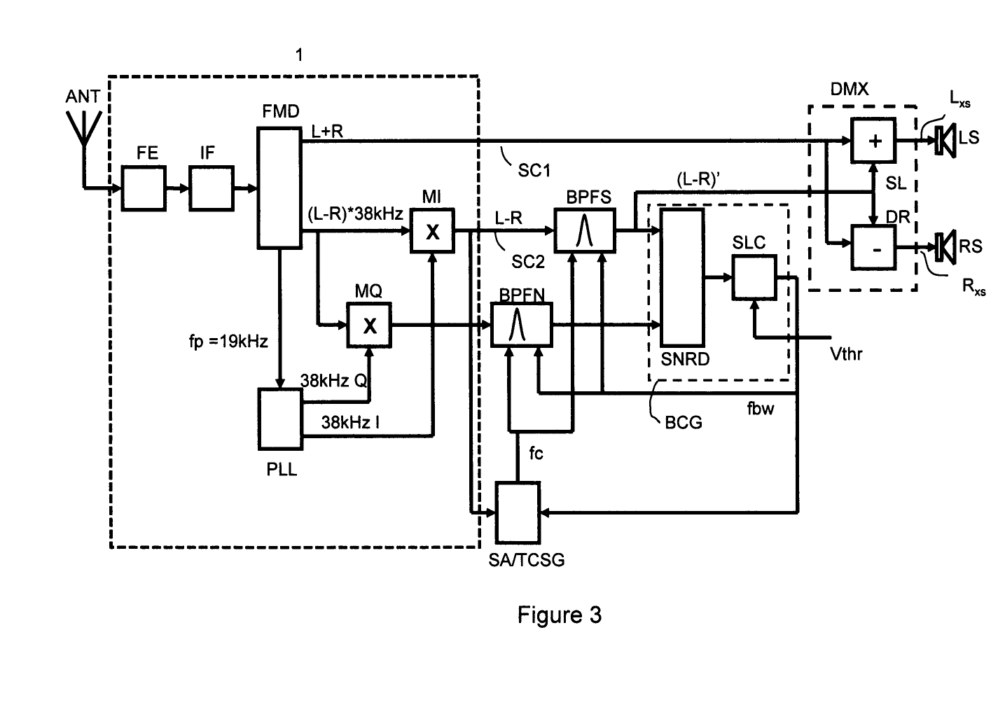

FM stereo broadcast receivers typically include an RF tuning stage, in which a wanted RF FM stereo signal is being converted into an IF FM stereo signal, followed by an FM demodulator for a demodulation of the IF FM stereo signal into a baseband stereo multiplex signal, hereinafter also referred to as stereo input signal. The baseband stereo multiplex signal includes a baseband (L+R) sum signal of stereo left (L) and stereo right (R) signals and a double sideband amplitude modulated (L−R) difference signal of said stereo right (R) and stereo left (L) signals with 38 kHz suppressed subcarrier frequency, such as shown in FIG. 3. To stabilize demodulation of the amplitude modulated (L−R) difference signal, a 19 kHz pilot carrier is included in the frequency gap of stereo multiplex signal between the frequency spectra of the baseband sum signal and amplitude modulated difference signal. The baseband sum and difference signals are demultiplexed in a stereo demultiplexer into left (L) and right (R) reproduction signals to be reproduced in stereo left and stereo right speakers.

FM broadcast reception suffers from various noise interferences, such as natural radio noise, unintentional man-made radio noise, and noise inherent to electronic components used in the receiver design. Such noise interferences cause background hiss noise in the speaker output. The magnitude of hiss noise generally increases as the RF signal reception strength, also referred to as RF fieldstrength, decreases.

FM broadcast reception is also affected by so called multipath interference occurring when multiple signals of the same frequency arrive at a receiving antenna through various propagation paths, due to reflections. Since these multiple signals traveled different distances, they are often out of phase with respect to each other, and thus combine to a greater or lesser degree destructively at the receiving antenna. In a mobile receiver, this multipath distortion creates amplitude fluctuations and spurious phase modulations, because the amplitude and phase of each arriving signal varies with time as the location of the antenna moves. Due to the shifting in phase of the 38 kHz (L−R) difference signal subcarrier, multipath distortion disrupts FM stereo reception significantly more than monaural reception. Multipath interference in the stereo FM receiver causes clearly audible, intermittent bursts of noise and/or distortion in the audio output signal.

To reduce background hiss noise and other audio signal disturbances caused by the above noise and multipath interferences, it is known to reduce the audio bandwidth and/or stereo channel separation of the reproduced stereo signal. Where in the state of full stereo channel separation, the perceived location of the left and right audio sources matches accurately the actual location of the original audio sources, reduction of the stereo channel separation causes the apparent stereo image width, i.e. the area from which the sound appears to originate upon reproduction, as well as the noticeable noise level to decrease. Such reduction of the stereo channel separation is hereinafter also being referred to as stereo to mono blending. To avoid disturbingly perceivable stereo to mono switching actions from occurring, sliding stereo to mono blending is used in particular in FM receivers for mobile reception. In controlling the stereo to mono blending an optimum channel separation is sought in a trade off between the apparent stereo image width on the one hand and the noticeable noise level on the other hand. “Channel separation” or CHS as used throughout the specification, is defined in accordance with the EIA 560 Standard as the ratio of the output signal level on one channel to the level of the fundamental component of that signal measured on the second channel, expressed in dB.

From U.S. Pat. No. 7,715,567 it is known to split the baseband (L+R) sum and (L−R) difference signals in a plurality of fixed, predetermined audio subbands of corresponding bandwidths. Each bandwidth is chosen to correspond to a socalled critical bandwidth, which is defined to cover tones, which are summarized by the human ear to one entire sound intensity. The signals within each audio subband are controlled in stereo channel separation while taking into account the masking effects on the perception of noise of the human auditory system, This is obtained by attenuating the signals within each respective subband of the stereo difference signal with a noise component of signals within this subband lying above a masking threshold of the stereo signal of this subband until the noise component of the signals within this subband lies below the masking threshold.

This, however, results in particular at high noise levels in such reduction of the stereo channel separation, that ultimately only mono reproduction of the (L+R) sum signal remains, causing complete loss of any directional sound sensation. Transitions back from lack of any directional sound sensation to stereo reproduction, even when applied gradually, are in practice being experienced as unnatural and disturbing.

Furthermore, in this conventional sliding stereo to mono blending method, adaptive filters are being used to split the sum- and difference signals into a number of audio subbands. The filter characteristics of these subband filters mutually vary with the audio signal, resulting in likewise varying group delays. In practice these continuously varying group delay differences are difficult to compensate and strongly affect the stereo channel separation.

In consequence, amongst other things, it is an object of the present invention to provide an improved method to reduce noise included in a stereo reproduction signal, which is applicable not only in FM receivers but in all types of stereo reproduction devices.

Another object of the invention is to maintain the sensation of stereo sound reproduction throughout the full control range of stereo to mono blending systems.

Now therefore, the method for reducing noise included in a stereo reproduction signal according to the invention is characterized by the steps of:
varying channel separation of said stereo reproduction signal with frequency within the frequency range of the stereo input signal in accordance with the frequency response of a filter selectivity located around a non-zero center frequency to obtain a channel separation peak value at said center frequency;
at a continuing increase of said noise, decreasing the bandwidth of said filter selectivity to a predetermined non-zero bandwidth.

A stereo signal processing device for reducing noise included in a stereo reproduction signal derived from a stereo input signal, including first and second channels receiving respectively first and second signal components of said stereo input signal, is characterized by filtering means located around a non-zero center frequency and being coupled between said first and second stereo channels for a variation of the channel separation of said stereo reproduction signal as defined by the frequency response of said filtering means, obtaining a channel separation peak value at said center frequency, SNR detection means generating a bandwidth control signal varying with the SNR of at least part of said stereo input signal, said bandwidth control signal at a continuing decrease of the SNR of said stereo input signal decreasing the bandwidth of said filtering means to a predetermined non-zero value and vice versa.

An FM receiver comprising an RF/IF front end converting an RF FM stereo signal into an IF FM stereo signal being coupled to stereo demodulator means for demodulating said FM IF signal into first and second signal components of a baseband stereo signal according to the invention is characterized by such stereo signal processing device.

The invention is based on the insight that the exclusion of a relatively small audio range of only some Hz within the stereo reproduction signal, from the trade-off between channel separation and noise when denoising such stereo reproduction signal, is sufficient to secure an effective stereo impression throughout the full denoise or noise reduction range.

Unlike the conventional noise reduction system of U.S. Pat. No. 7,715,567, in which within its noise reduction control range, the audio signals in subbands of a difference signal (L−R) of predetermined fixed bandwidths are attenuated dependent on the noise component lying above a masking threshold of the stereo signal of the respective subbands, the invention effectuates noise reduction within the noise reduction control range from a minimum RMS SNR (Root Mean Square Signal to Noise Ratio) to a maximum RMS SNR by decreasing the bandwidth of the filter selectivity from a predetermined maximum bandwidth to a predetermined non-zero minimum bandwidth. This causes the stereo channel separation to likewise decrease in correspondence with the frequency response of the filter selectivity.

As even at said maximum RMS SNR, the bandwidth of the filter selectivity is not decreased below the predetermined non-zero minimum bandwidth, the peak channel separation between the left and right audio signals of the stereo reproduction signals occurring at or substantially at the center frequency of said filter selectivity remains intact throughout the full noise reduction control range. By a proper choice of the non-zero minimum bandwidth an effective directional sound sensation of the stereo reproduction signal within the bandwidth of the filter selectivity is secured throughout the full noise reduction range.

In a practical embodiment a channel separation between said left and right audio signals exceeding 6 dB does not lead to loss of directional sound sensation of the stereo reproduction signal. Because of this typical distinction with conventional methods of noise reduction, the method in accordance with the invention, is hereinafter referred to as extended stereo or XS blending, whereas the stereo left and stereo right audio signals obtained upon reproduction by applying the invention, are being referred to as Lxs, respectively Rxs.

In the bandwidth and frequency position of the filter selectivity, the invention provides extra degrees of design freedom allowing for a more accurate balance between noise reduction and stereo channel separation within its XS blending range compared with conventional stereo to mono blending.

The invention is applicable to stereo input signals with first and second stereo signal components being constituted by respectively baseband (L+R) sum and (L−R) difference signals, hereinafter also referred to as stereo multiplex signal, and/or alternatively to stereo input signals with baseband left (L) and right (R) signals.

When applied to a stereo multiplex signal comprising (L+R) sum and (L−R) difference signals of said left and right input signals, L and R, respectively, the invention is preferably characterized by the steps of:
deriving said filter selectivity from bandpass filter means to select an auxiliary difference signal (L−R)′ from the stereo difference signal (L−R);
demultiplexing said sum signal (L+R) with the auxiliary difference signal (L−R)′ to obtain the left and right reproduction signals (Lxs, respectively Rxs).

When applied to a stereo input signal with baseband left (L) and right (R) signals, the invention is preferably characterized by the steps of:
deriving said filter selectivity from bandstop filter means selecting auxiliary left and right signals, L′ and R′, from said left and right input signals L and R, respectively;
summing the left input signal L and the auxiliary right signal R′ to obtain the left reproduction signal (Lxs);
summing the right input signal R and the auxiliary left signal L′ to obtain the right reproduction signal (Rxs).

To allow for a reliable, automatic bandwidth control of the filter selectivity in response to the SNR level of the stereo input signal, the invention may preferably be characterized by the steps Of:
measuring the RMS SNR of said further auxiliary (L−R) difference signal;
varying the bandwidth of the filter selectivity in response to said RMS SNR.

This type of bandwidth control constitutes a negative feedback control loop enabling stabilization of the RMS SNR of the reproduction stereo signal at a predetermined RMS SNR reference level.

The invention may use a tuneable filter selectivity, or alternatively a filter selectivity at a predetermined fixed frequency location within the audio frequency range of the stereo signal.

When using a tuneable filter selectivity, the invention is preferably characterized by the steps of:
measuring the RMS SNR within the frequency range of a (L−R) difference signal between the stereo left (L) and stereo right (R) signals of said stereo input signal;
determining the center frequency of a frequency window within the frequency range of a (L−R) difference signal with bandwidth Δfw, in which the RMS SNR relative to said bandwidth Δfw is maximal;
   tuning the center frequency of the filter selectivity to said frequency position.

By applying these measures according to the invention, the center frequency of the tuneable filter selectivity is determined by that frequency subrange within the frequency range of the stereo signal, covering maximum audio RMS SNR.

Preferably, the bandwidth of said frequency window Δfw is being controlled to correspond to the bandwidth of the 3 dB bandwidth of the filter selectivity.

When using a filter selectivity at a predetermined fixed frequency location within the audio frequency range, the invention is characterized in that the center frequency of the filter selectivity is chosen at a predetermined frequency within the upper half of the sensitivity range of the human ear, preferably at substantially 1 kHz.

Embodiments of the stereo signal processing device and the FM receiver implementing the invention are defined in claims 7-15 and 16-18, respectively.

The various features of novelty in design and function which characterize the present invention as defined in the claims annexed to and forming part of this disclosure, will be discussed in more detail hereinafter with reference to the disclosure of preferred embodiments, wherein like or similar elements are designated by the same reference numeral through the several drawings, that show in:

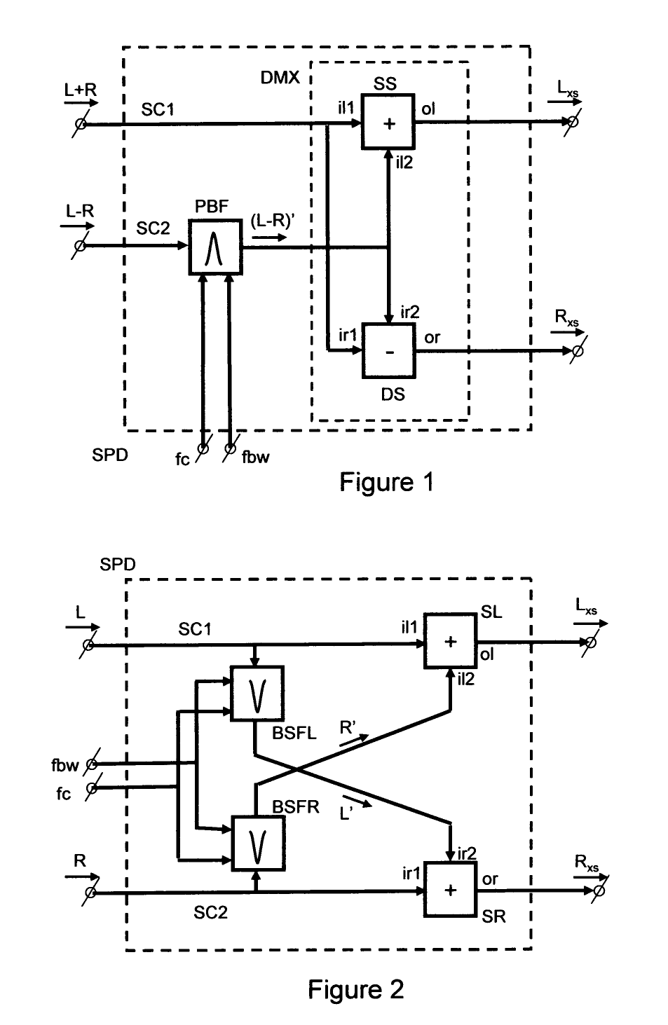

FIG. 1 an embodiment of a stereo signal processing device implementing the method of reducing noise in a stereo reproduction signal according the invention applied to a stereo input signal comprising sum and difference signals (L+R) and (L−R), respectively;

FIG. 2 an embodiment of a stereo signal processing device implementing the method of reducing noise in a stereo reproduction signal according the invention applied to a stereo input signal comprising stereo left and stereo right signals (L) and (R), respectively;

FIG. 3 a first embodiment of an FM receiver according to the invention using the stereo signal processing device of FIG. 1;

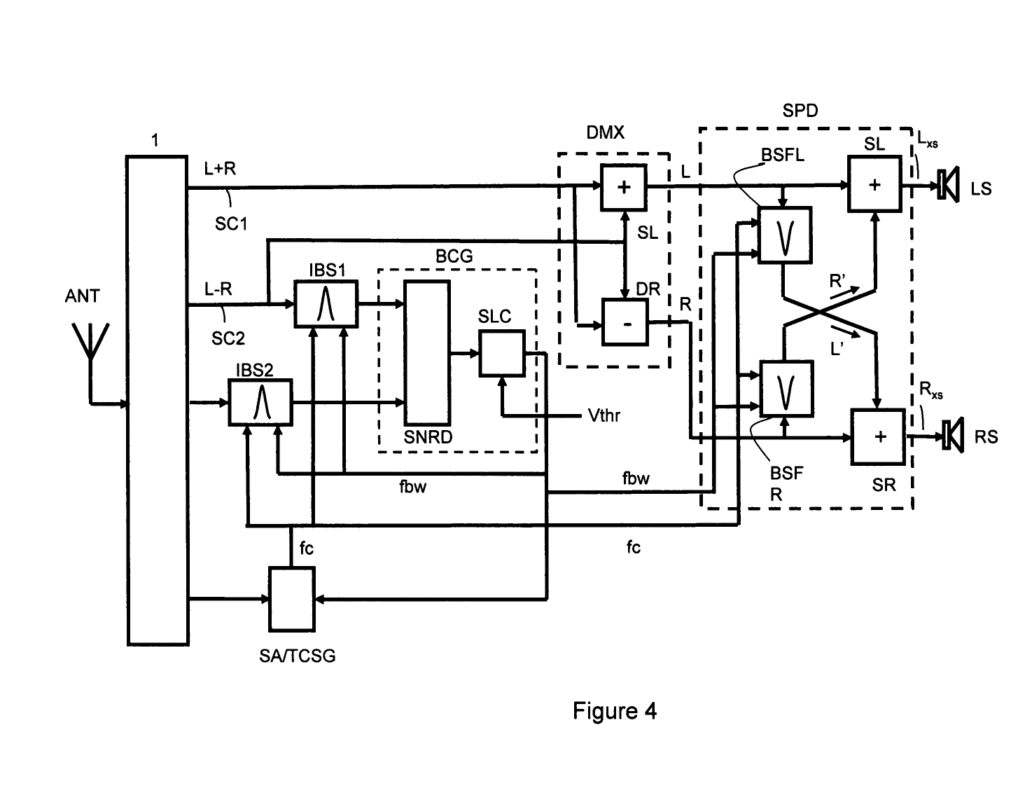

FIG. 4 a second embodiment of an FM receiver according to the invention for use with the stereo signal processing device of FIG. 2;

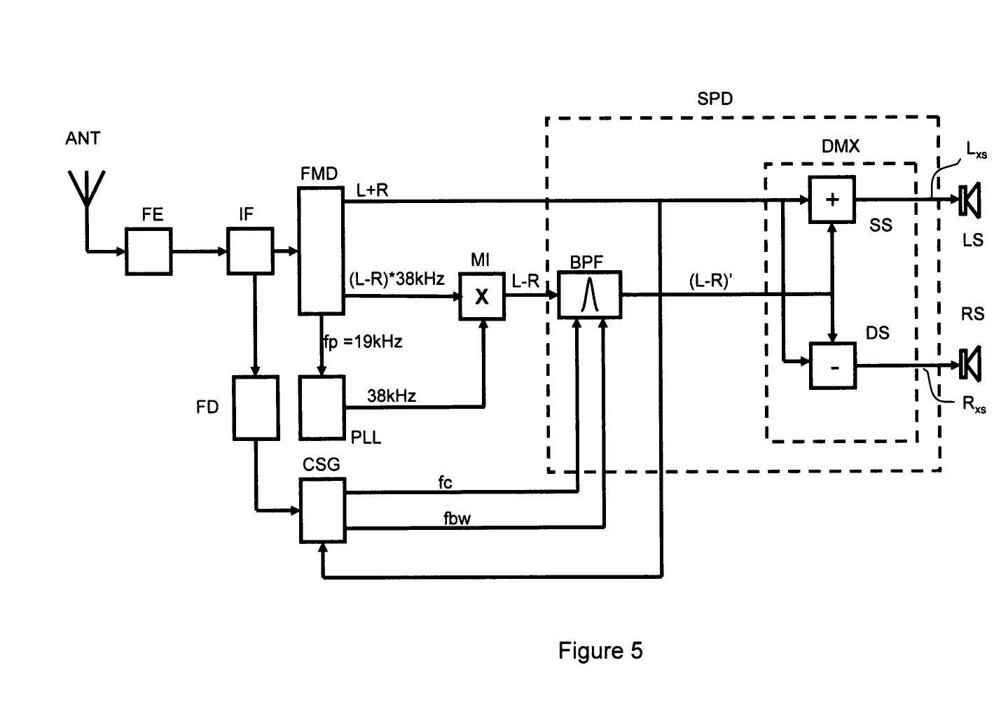

FIG. 5 a third embodiment of an FM receiver according to the invention with a feedforward bandwidth control applied to the stereo signal processing device of FIG. 1;

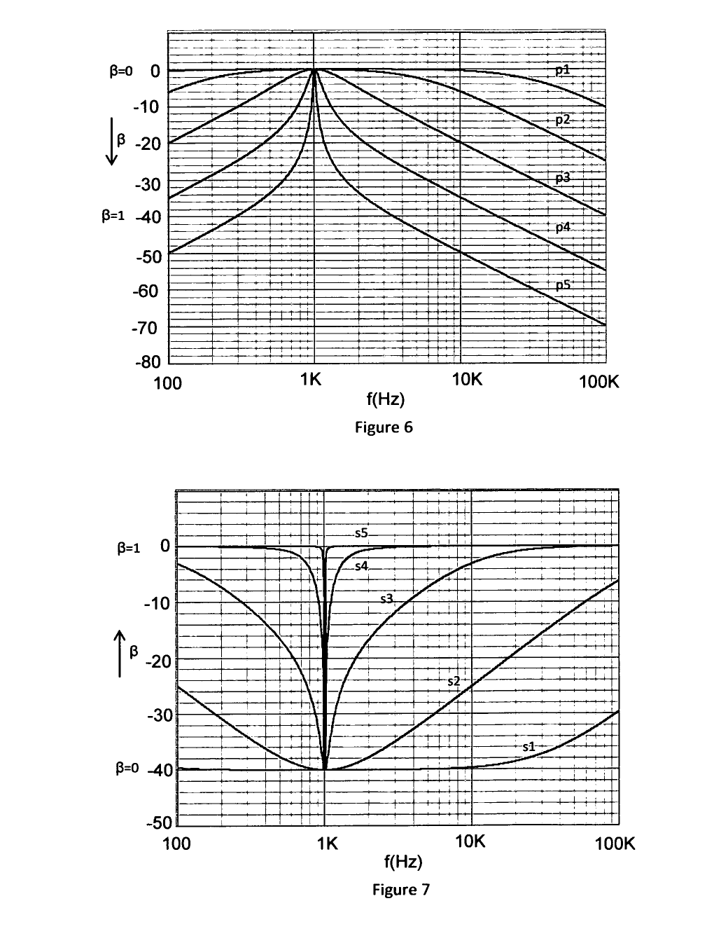

FIG. 6 various filter characteristics of a bandpass filter for use in the embodiments of FIGS. 1 and 3 defining the frequency dependent channel separation according to the invention;

FIG. 7 various filter characteristics of bandstop filters for use in the embodiments of FIGS. 2 and 4 defining the frequency dependent channel separation according to the invention;

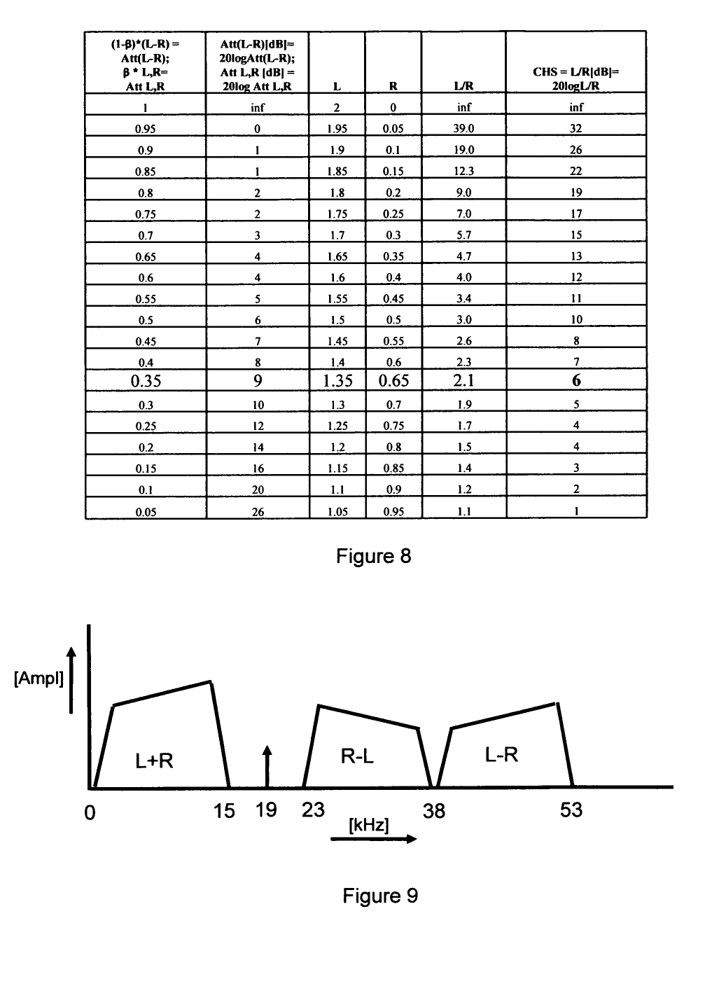

FIG. 8 a table of blending rates and channel separation values;

FIG. 9 the frequency spectrum of a stereo multiplex signal, including sum and difference signals (L+R) and (L−R), respectively;

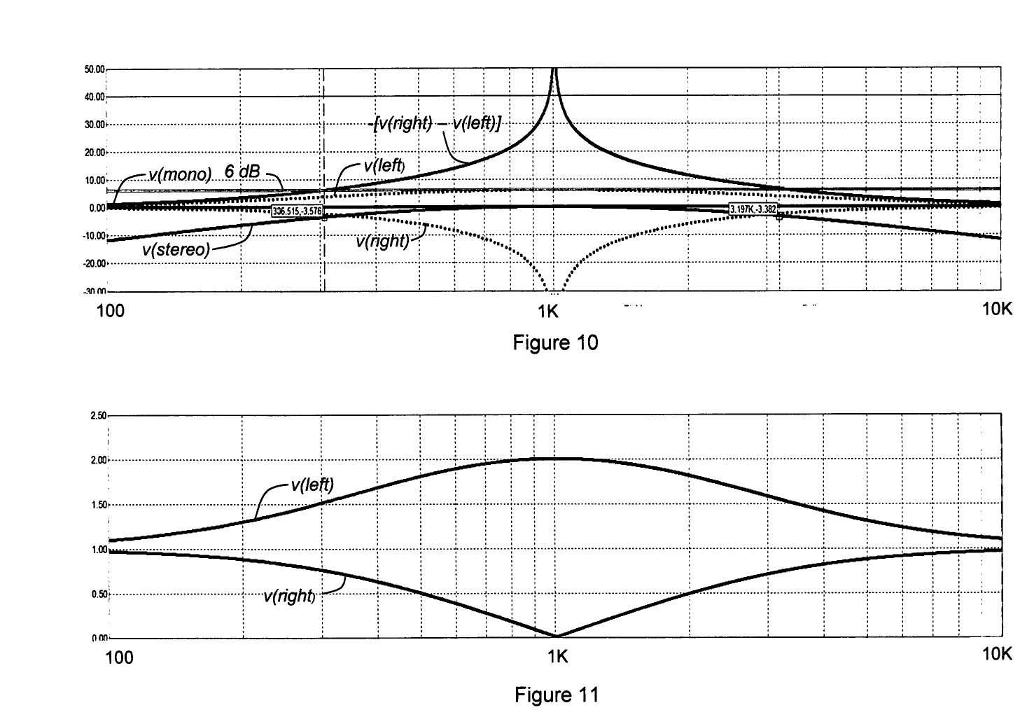

FIG. 10-14 test curves derived from a simulation of the embodiment of FIG. 1 at various attenuation rates of the auxiliary difference signal (L−R)′ at fc=1 kHz of a first order LC bandpass filter PBF as listed in the table of FIG. 8.

FIG. 1 shows a stereo signal processing device SPD implementing the method for reducing noise in a stereo reproduction signal according to the invention and applied to a stereo multiplex input signal comprising baseband sum and difference signal components (L+R) and (L−R), respectively. These baseband components are derived from a stereo multiplex signal as shown in FIG. 9 by selection of the baseband sum signal (L+R) and 38 kHz in-phase demodulation of the double sideband suppressed carrier modulated difference signal (L−R).

The device SPD includes first and second stereo channels SC1, respectively SC2, receiving respectively the baseband sum and difference signal components (L+R) and (L−R), respectively, of said stereo multiplex input signal. The first stereo channel SC1 is coupled to first inputs il1, respectively ir1 of summing and differential stages SS, respectively DS, constituting demultiplexer means DMX. The second stereo channel SC2 is coupled to a logarithmic first order LC bandpass filter PBF, which is controllable in its bandwidth fbw and in the frequency location of its center frequency fc. Curves p1-p5 in FIG. 6 show the amplitude response of the bandpass filter PBF located around a center frequency of 1 kHz, at various stepwise decreasing bandwidth settings. Due to its first order transfer characteristic the phase shift of the bandpass filter PBF phase at its center frequency is zero. The term “filter frequency response” as used throughout the specification, and in the claims, is understood to be the overall transfer characteristic of a filter as defined by its frequency dependent amplitude and phase responses. This means that stereo channel separation as implemented in this FIG. 1 varies with frequency in accordance with the frequency response of the bandpass filter PBF as defined by both its amplitude and phase filter responses. For a simple explanation and first order approach of the invention, the effect of the phase filter response is ignored and the invention is described as if the frequency response of BPF were defined by its amplitude response only, as follows.

Bandpass filter PBF selects from the difference signal (L−R) an auxiliary difference signal (L−R)′. This auxiliary stereo difference signal (L−R)′ is supplied to second inputs il2 and ir2 of said summing and differential stages SS and DS, respectively.

The summing stage SL adds the auxiliary difference signal (L−R)′ to the baseband sum signal (L+R), providing at its output of a left stereo reproduction signal Lxs.

In Lxs the original left input signal L is blended with the original right input signal R with a blending rate β varying with frequency in accordance with the frequency response of the bandpass filter BPF as will be explained with reference to FIG. 6.

The difference stage DR subtracts the auxiliary difference signal (L−R)′ from the baseband sum signal (L+R), providing at its output or a right reproduction signal Rxs. In Rxs the original right input signal R is blended with the original left input signal L with the same blending rate β as referred hereabove with respect to the left reproduction signal Lxs.

Turning now to FIG. 6, filter curves p1-p5 are derived from a first order bandwidth controllable logarithmic LC bandpass filter PBF having a resonance frequency at 1 kHz. As known, the resonance frequency of such first order LC bandpass filter deviates somewhat from the exact logarithmic center frequency fc. In practice, the difference between those two frequencies is relatively small, reason for which the term center frequency fc throughout the claims and description should be considered to also refer to resonance frequency, or more in general, to a frequency within a relatively small frequency range around the center frequency fc, e.g. the 3 dB bandwidth range.

Filter curves p1 to p5 illustrate different amplitude filter responses of the bandpass filter PBF at a decreasing bandwidth, located around said center frequency of 1 kHz, each effecting the auxiliary difference signal (L−R)′ in its amplitude accordingly. As a result thereof, the left and right reproduction signal Lxs and Rxs, respectively, obtained after demultiplexing of the stereo sum signal (L+R) with said auxiliary difference signal (L−R)′, are likewise being effected, in that the stereo channel separation between those left and right reproduction signal Lxs and Rxs correspond to the frequency responses of the bandpass filter BPF as shown with the filter curves p1-p5. According to the invention, the frequency response of the bandpass filter PBF defines the occurrence of a maximum or peak value of the stereo channel separation at said center frequency, which essentially remains unchanged within the bandwidth variation range of said bandpass filter BPF. For a proper application of the invention a channel separation of at least 6 dB suffices as will be explained in more detail with reference to the table of FIG. 8.

With a blending rate β varying from β32 0 at full stereo separation or zero stereo crosstalk to β=1 at complete loss of stereo separation or full mono, the method of stereo noise reduction according to the invention turns a low SNR stereo signal with sum and difference signals, respectively (L+R) and (L−R), or with left and right signals L, respectively R, into a high SNR XS signal with left and right XS signals Lxs, respectively Rxs, with Lxs=L+β*R and Rxs=R+β*L, while maintaining an effective sensation of stereo sound reproduction within the full noise reduction or blending range. A compensation for β related amplitude variations within the blending range is obtained with Lxs=0.5*{2L−β*(L−R)} and Rxs=0.5*{2R+β*(L−R)} varying from Lxs=L, respectively Rxs=R for β=0 to Lxs=Rxs=0.5*(L+R) for β=1.

Suppose the blending range, and therewith the range of channel separation, in which β increases from 0 to 1, is chosen to extend from an attenuation of 0 dB to an attenuation of −40 dB at the vertical axis, whereas the audio frequency range extends from 100 Hz to 20 kHz at the horizontal axis. A bandwidth setting of the bandpass filter in accordance with curve p1 results in β varying from β=0 (i.e. full stereo separation) at 1 kHz to approximately β=0.15 at 100 Hz and β=0.04 at 20 kHz. In practice, such relatively small β variation hardly effects the sensation of full stereo sound reproduction. To increase stereo denoising e.g. for a compensation of a decrease in the stereo SNR level, the bandwidth of the bandpass filter is decreased to result in a frequency response e.g. as shown with filter curve p2. At an increasing audio frequency within the audio frequency range, the blending rate β now decreases from β=0.5 at 100 Hz to β=0 at 1 kHz, and from there increases to β=0.65 at 20 kHz. This results in a channel separation at 100 Hz defined by Lxs=0.5*{2L−0.5*(L−R)}=0.75L+0.25R and Rxs=0.5*{2R+0.5*(L−R)}=0.75R+0.25L, at 1 kHz defined by Lxs=L and Rxs=R and 20 kHz defined by Lxs=0.5*{2L−0.65*(L−R)}=0.7L+0.3R and Rxs=0.5*{2R+0.65*(L−R)}=0.7R+0.3L. Compared with filter curve p1, curve p2 shows an increase not only in the width of the audio frequency ranges effected by blending, but also in the blending rate β applied to the signals within those audio frequency ranges. This results in an improvement of the SNR figure of the stereo signal at the expense of the overall channel separation. However, by applying the invention, this trade off affects the sensation of stereo sound reproduction to a much lesser degree for a certain SNR increase, than with conventional stereo mono blending. According to the invention, an effective channel separation securing the sensation of stereo sound reproduction, is maintained at the 1 kHz center frequency of the bandpass filter. Although such effective channel separation only occurs at this single 1 kHz frequency, it will be clear from filter curve p2, that in practice the sensation of stereo sound reproduction extends to an audio range around 1 kHz for which the increase in β is relatively small, hereinafter referred to as audio subband. Suppose an increase of e.g. β=0.15 (corresponding to the blending rate at 100 Hz in curve p1) does not noticeably affect the sensation of stereo sound reproduction. Then in filter curve p2, such audio subband may range approximately from e.g. 450 Hz to 2.3 kHz. Due to the properties of the human auditory system, limiting full or near full stereo channel separation to said audio subband, hardly affects an overall directional sound sensation of stereo sound reproduction.

By further decreasing the bandwidth of the bandpass filter, e.g. to further increase stereo denoising, filter responses as shown e.g. by curves p3-p5 are obtained, defining a decreasing width of the above defined audio subband and an increasing blending rate β for the audio frequency ranges outside the audio subband. The filter response as shown with curve p5 defining the smallest bandwidth of the bandpass filter, also referred to as the predetermined non-zero bandwidth, decreases below the attenuation level of −40 dB at approximately 200 Hz and 2.5 kHz. In the example for the blending range, the −40 dB level defines the upper range limit. Consequently, the stereo input signal within the audio frequency ranges from 100-200 Hz and 2.5-20 kHz after being denoised in accordance with curve p5, is being reproduced as a full mono sound signal by left and right XS signals Lxs, respectively Rxs, in which Lxs=Rxs=0.5*(L+R).

Even in the asymptotic setting at the predetermined non-zero bandwidth as shown with curve p5, in which the audio subband is only some tenths of Hz wide, a certain sensation of directional sound reproduction is maintained. The more so, in that the center frequency of the audio subband is chosen at 1 kHz for which the human auditory system is highly sensitive. In practice, any choice of the center frequency within the upper half of the sensitivity range of the human ear will more or less provide a similar effect. This contrasts with conventional stereo to mono blending effecting the complete audio spectrum and leading to complete loss of directional sound sensation at high stereo SNR levels.

It will be clear that vice versa, an increase in stereo perception, e.g. at a decrease in stereo SNR level, can be obtained by increasing the bandwidth of the bandpass filter.

As stated above, in practice the frequency response of the bandpass filter BPF is not only defined by the amplitude response but also by the phase response thereof. This means that the blending rate and therewith the channel separation will somewhat deviate from the curves p1-p5 as shown. The phase response of the first order LC bandpass filter BPF at its center frequency is 0, securing full stereo channel separation at said center frequency throughout the full bandwidth variation range from p1 to p5.

The increase in selectivity, resulting from the latter decrease in bandwidth, narrows down the audio subband, in which full and/or near full stereo sound reproduction of the original left and right signals L respectively R occurs. In the example of a blending rate β ranging from β=0 to β=1 for filter attenuations between 0 dB and −40 dB, as referred to with respect to FIG. 6 and a curve p5 frequency response of the bandpass filter BPF, Lxs varies from L at 1 kHz through a curve p5 defined blending with R to finally Lxs=0.5*(L+R) in the audio frequency ranges from 100-200 Hz and 2.5-20 kHz. Likewise, Rxs varies from R at 1 kHz through a curve p5 defined blend with L to finally Rxs=0.5*(L+R) in the same audio frequency ranges.

This results in a full and/or near full stereo sound reproduction of the original left and right input signals L, respectively R, for audio frequencies within the audio subband around the center frequency of the bandpass filter BPF as defined above. For audio frequencies moving away from the audio subband, the stereo channel separation gradually decreases in accordance with the curve p5 frequency response of the bandpass filter BPF to finally full mono sound reproduction of (L+R) in the audio frequency ranges from 100-200 Hz and 2.5-20 kHz.

Bandpass filter BPF in FIG. 1 is also controllable in its center frequency fc to tune the audio subband to an audio frequency, for which the human auditory system is highly sensitive within the actual audio power spectrum. Parameters for an optimization in the determination of such audio frequency include RMS SNR of the stereo signal and/or the part thereof covered by the audio subband and the audio subband bandwidth, as will be explained in more detail with reference to FIG. 3.

FIG. 2 shows a stereo signal processing device SPD implementing the method for denoising a stereo signal according to the invention and applied to a stereo input signal with baseband left and right input signals L and R, respectively.

The device SPD includes first and second stereo channels SC1, respectively SC2, receiving respectively said baseband left and right input signals L and R, coupled to respective first inputs il1, ir1 of first and second signal summing stages SL, respectively SR. The respective first and second stereo channels SC1 and SC2 are coupled to mutually identical stereo left and stereo right bandstop filters BSFL and BSFR. The bandstop filters BSFL and BSFR are controllable in bandwidth and center frequency, and respectively configured to select auxiliary left and right signals L′ and R′ from the left and right input signals L and R. The auxiliary left and right signals L′ and R′ are attenuated with respect to the left and right input signals L and R according to the frequency response of stereo left and stereo right bandstop filters BSFL and BSFR. The auxiliary left and right signals L′ and R′ are respectively supplied to second inputs ir2, il2 of said second and first summing stages SR and SL to be added therein to the left and right input signals L and R. These summing operations result in right and left reproduction signals Rxs and Lxs provided at outputs or and ol of said second and first summing stages SR and SL. The so obtained stereo left and right reproduction signal Lxs and Rxs, respectively, reflect the frequency response of stereo left and stereo right bandstop filters BSFL and BSFR, causing the channel separation between those stereo left and right reproduction signal Lxs and Rxs to correspond to the frequency responses of the bandstop filters BSFL and BSFR. According to the invention, the frequency responses of the bandstop filters BSFL and BSFR define the occurrence of a maximum or peak value of the channel separation at said center frequency, which essentially remains unchanged within the bandwidth variation range of said bandpass filter BPF. With a blending rate β varying from β=0 at full channel separation to β=1 at complete loss of channel separation, channel separation CHS is defined by Lxs=0.5*{2L−β*(L−R)} and Rxs=0.5*{2R+β*(L−R).

Turning now to FIG. 7, filter curves s1-s5 show the frequency response of each of the stereo left and stereo right bandstop filters BSFL, respectively BSFR at various stepwise decreasing selectivity or bandwidth settings, in which these bandstop filters are first order bandwidth controllable logarithmic bandstop filters with a resonance frequency at 1 kHz. In practice such filters are preferably digitally implemented. Further elaboration of these filters is not needed for a proper understanding of the invention, as the implementation of thereof lies within the ability of anyone skilled in the art. The resonance frequency of such first order bandstop filters may deviate somewhat from the exact logarithmic center frequency, however, in practice, the difference between those two frequencies is relatively small. For this reason, the term center frequency throughout the claims and description should be considered to also refer to frequencies within a relatively small frequency range around the center frequency in the order of magnitude of the frequency difference between the center and the resonance frequency.

The method of FIG. 2 is dual to the method of FIG. 1, in that the β defining filter curves s1-s5 are now derived from frequency responses of a first order bandstop filter having a resonance frequency at 1 kHz. The description of the operation of the bandpass filter PBF in FIG. 1 and the control of its bandwidth applies mutatis mutandis to each of the stereo left and stereo right bandstop filters BSFL, respectively BSFR, in that stereo denoising in accordance with the invention is obtained by decreasing the bandwidth of the stereo left and stereo right bandstop filters BSFL, respectively BSFR, while maintaining full stereo channel separation at the center frequency of those filters.

In contrast with FIG. 6, the blending rate β in FIG. 7 increases with decreasing filter attenuation, for example a blending range in which β increases from β=0 to β=1 may be chosen to extend from an attenuation of −40 dB to 0 dB at the vertical axis, whereas the audio frequency range may be chosen to extend from 100 Hz to 20 kHz at the horizontal axis.

By way of example: full channel separation is obtained with a frequency response of the bandstop filter as shown with curve s1. This curve s1 is flat within the full audio frequency range, with exception of a negligible increase of β at 20 kHz, therefore defining full spectrum stereo sound reproduction of the left and right input signals with Lxs=L and Rxs=R.

To increase stereo denoising the bandwidth of the bandstop filters is decreased, resulting in a frequency response, e.g. corresponding to filter curve s2. At an increasing audio frequency within the audio frequency range, the blending rate β now decreases from β=0.38 at 100 Hz to β=0 at 1 kHz, and from there increases to β=0.5 at 20 kHz. According to the invention, full channel separation is maintained at the 1 kHz center frequency of the bandstop filter. However, filter curve s2 shows a range or audio subband around 1 kHz for which the increase in β is negligibly small. In practice audio signals within this audio subband, are perceived as being reproduced with full channel separation. If e.g. a value for β of 0.15 qualifies as negligibly small, then for curve s2, such audio subband may range approximately from e.g. 300 Hz to 3.5 kHz. Due to the properties of the human auditory system, limiting stereo sound reproduction to said audio subband, hardly affects an overall acceptable sensation of stereo sound, allowing for a much larger SNR increase of the stereo reproduction signal than possible with conventional blending systems.

The above description of the invention with respect to pass band filter curves p3-p5 holds mutatis mutandis for the band stop filter curves s3-s5 as well.

In the bandwidth and frequency position of the filter selectivity in both FIGS. 6 and 7, the invention provides extra degrees of design freedom allowing for a more accurate balance between noise reduction and stereo channel separation within its XS blending range compared with conventional stereo to mono blending.

The center frequency of the filter selectivity can be chosen at a certain predetermined frequency preferably within the upper half of the sensitivity range of the human ear e.g. 1 kHz.

Or, alternatively, by dynamically tuning the center frequency of the bandpass filter to an audio frequency, which in the actual audio power spectrum is maximal sensitive to the human auditory system, taking into account a.o. masking effects, as will be explained hereafter in more detail. This may be obtained by:
measuring the RMS SNR within the frequency range of a difference signal (L−R) defined by the difference between the left and right input signals, L and R, respectively, of said stereo input signal;
determining the center frequency of a frequency window within the frequency range of said difference signal (L−R) with bandwidth Δfw, in which the RMS SNR relative to said bandwidth Δfw is maximal;
tuning the center frequency of the filter selectivity to said frequency position.

This allows for a further reduction in the predetermined non-zero bandwidth while maintaining acceptable sensation of stereo sound reproduction.

The bandwidth of said frequency window Δfw may be chosen to correspond to the bandwidth of the filter selectivity.

The relation between blending rate β and channel separation CHS as referred to in the above is clarified in the table of FIG. 8.

In practice, due to spread and environmental phenomena, the channel separation CHS occurring at the center frequency of bandpass filter PBF of FIG. 1 and bandstop filters BSFL and BSFR of FIG. 2, also referred to as channel separation peak value, may deviate within the bandpass control range of these filterselectivities from the 0 dB attenuated full channel separation with Lxs=L and Rxs=R.

An effective sensation of stereo sound reproduction of the audiosignals at the center frequency of the passband filterselectivity PBF or bandstop filterselectivities BSFL and BSFR is secured for channel separation values exceeding 6 dB.

FIG. 3 shows a first embodiment of an FM receiver according to the invention, comprising an RF/IF front end FE receiving and selecting an RF FM reception signal from antenna means ANT and converting the same into an IF FM signal. The IF FM signal is subsequently IF selected in IF unit IF and coupled to an FM stereo demodulator FMD for demodulating said FM IF signal into a baseband stereo multiplex input signal as shown in FIG. 3 and splitting the same into:
a baseband sum signal (L+R) being supplied through a first stereo channel SC1 to first inputs of summing and differential stages SL, respectively DR, constituting demultiplexer means DMX,
a double sideband amplitude modulated difference signal (L−R) being supplied to signal inputs of in-phase and phase quadrature demodulators MI, respectively MQ, and
a 19 kHz pilot signal being supplied as a reference signal to a PLL circuit PLL. The PLL circuit PLL generates in-phase and phase quadrature 38 kHz subcarrier signals, which are respectively supplied to carrier inputs of said in-phase and phase quadrature demodulators MI, respectively MQ.

The in-phase demodulator MI demodulates the double sideband 38 kHz amplitude modulated (L−R) difference signal into a baseband difference signal (L−R), which is supplied to a signal bandpass filter BPFS corresponding in operation and functionality to the bandpass filter BPF of FIG. 1. Signal bandpass filter BPFS selects an auxiliary difference signal (L−R)′ from the baseband difference signal (L−R) to be supplied to second inputs of the summing and differential stages SL, respectively DR, and to a signal input of SNR detection means SNRD.

In demultiplexer means DMX the auxiliary difference and sum signals (L−R)′ and (L+R) are demultiplexed into left and right reproduction signal Lxs and Rxs, which are reproduced in left and right loudspeakers L and R, respectively.

The phase quadrature demodulator MQ demodulates the noise spectrum within the baseband difference signal (L−R). This noise spectrum is supplied to a noise bandpass filter BPFN, which is identical to the signal bandpass filter BPFS, to select therefrom an auxiliary noise signal representing the noise signal of the auxiliary difference signal (L−R)′ to be supplied to a noise input of the SNR detection means SNRD included in a bandwidth control signal generator BCG. The SNR detection means SNRD is configured to define the RMS SNR of the auxiliary difference signal (L−R)′. Such SNR detection means SNRD is on itself known, e.g. from the above cited U.S. Pat. No. 7,715,567.

The RMS SNR of the auxiliary difference signal (L−R)′ is supplied to a SNR set level circuit SLC, in which an SNR set level Vthr is subtracted therefrom to form a bandwidth control signal fbw, which is negatively fed back to bandwidth control inputs of both signal and noise bandpass filters BPFS and BPFN. This results in a negative feedback bandwidth control of the signal and noise bandpass filters BPFS and BPFN effecting SNR stabilisation at the SNR setlevel.

The FM receiver is provided with a tuning control signal generator TCSG comprising a spectrum analyzer SA receiving the (L−R) difference signal from the first stereo channel SC1. The spectrum analyzer measures the RMS SNR of said difference signal (L−R). The tuning control signal generator TCSG is configured to determine the center frequency fcw of a frequency window with bandwidth Δfw covering an audio frequency range within the frequency range of a (L−R) difference signal, carrying an RMS SNR, which relative to said bandwidth Δfw, is maximal, and to derive from said center frequency fcw tuning data fc being supplied to tuning control inputs of the signal and noise bandpass filters BPFS and BPFN to simultaneously vary their center frequencies to the center frequency fcw of said frequency window. The implementation of such tuning control signal generator TCSG lies within the capabilities of the skilled person and the above description suffices for a proper understanding of the invention.

Alternatively, in order to dispense with the circuitry needed for a dynamic control of said center frequency e.g. to come to a more simple embodiment of the invention, the center frequencies of the signal and noise bandpass filters BPFS and BPFN can be chosen at a certain fixed predetermined frequency within the upper half of the sensitivity range of the human auditory system allowing to select the auxiliary difference signal (L−R)′ from the difference signal (L−R) without affecting phase and amplitude at said center frequency while.

Preferably, signal and noise bandpass filters BPFS and BPFN each includes a first order LC band pass filter, which is configured to select a logarithmic band pass range around a center frequency of substantially 1 Khz.

FIG. 4 shows a second embodiment of an FM receiver according to the invention for use with the embodiment of FIG. 2, in which circuitry 1 corresponds to circuitry 1 of FIG. 3, including the RF/IF front end FE, the IF unit IF, the FM stereo demodulator FMD, the phase locked loop PLL and the in-phase and phase quadrature demodulators MI and MQ, respectively.

In contrast with FIG. 3, the baseband difference signal (L−R) is being supplied from the output of the in-phase demodulators MI to the second inputs of the summing and differential stages SL, respectively DR, of demultiplexer means DMX, as well as to a signal bandpass filter IBS1 corresponding in functionality with the signal bandpass filter BPFS of FIG. 3.

In the summing and differential stages SL, respectively DR, of demultiplexer means DMX, the baseband stereo sum signal (L+R) is demultiplexed with the baseband stereo difference signal (L−R) to obtain baseband left and right input signals L and R at the outputs of the summing and differential stages SL, respectively DR. These baseband left and right input signals L and R are supplied to a stereo signal processing device SPD which in functionality corresponds to the stereo signal processing device SPD of FIG. 2.

The noise spectrum within the baseband difference signal (L−R) is supplied from the output of the phase quadrature demodulator MQ to a noise bandpass filter IBS2, which is identical to the signal bandpass filter IBS1 and corresponds in functionality with the noise bandpass filter BPFN of FIG. 3. The negative feedback control of the bandwidth of both signal and noise bandpass filters IBS1 and IBS2 corresponds mutatis mutandis to the negative feedback control of the bandwidth of both signal and noise bandpass filters BPFS and BPFN of FIG. 3 and need no further amplification for a proper understanding of the invention. The frequency responses of bandpass filters IBS1 and IBS2 are reciprocal with respect to the frequency responses of the bandstop filters BSFL and BSFR as used in the stereo signal processing device SPD IBS1 and IBS2. The implementation of such reciprocally matched bandpass and bandstop filters lies within the knowledge and ability of anyone skilled in the art and is preferably realized in digital form. The bandwidth control signal fbw obtained with the negative feedback control of the bandwidth of both signal and noise bandpass filters IBS1 and IBS2 is supplied to bandwidth control inputs of the bandstop filters BSFL and BSFR of the stereo signal processing device SPD. The tuning data fc needed to tune the center frequency of the bandstop filters BSFL and BSFR of the stereo signal processing device SPD are generated in correspondence with the generation of such tuning data as described with reference to FIG. 3.

Alternatively, in order to dispense with the circuitry needed for a dynamic control of the center frequencies of the bandpass filters IBS1 and IBS2 and the bandstop filters BSFL and BSFR e.g. to come to a more simple embodiment of the invention, the center frequencies of these filters can be chosen at a certain fixed predetermined frequency within the upper half of the sensitivity range of the human auditory system, preferably at substantially 1 Khz.

FIG. 5 a third embodiment of an FM receiver according to the invention with a feedforward bandwidth control applied to the embodiment of FIG. 1.

The bandwidth control signal fbw and tuning data fc are being retrieved from a look-up table included in a control signal generator CSG and comprising a number of set values including bandwidth and/or tuning data for the bandpass filter BPF, allocated to the various levels of fieldstrength of the RF FM reception signal within the reception range. For this purpose, the IF signal is being supplied from the IF unit IF through a fieldstrength detector FD to the control signal generator CSG. The so retrieved bandwidth control signal Fbw and tuning data fc are being supplied to a controllable bandpass filter BPF selecting the auxiliary difference signal from the output of the in phase demodulator MI and included in a stereo signal processing device SPD corresponding to the stereo signal processing device SPD of FIG. 1.

FIG. 10 shows a signal plot covering an audio frequency range from 100 Hz to 10 kHz, with curve v(stereo) illustrating the frequency dependent variation of an auxiliary difference signal (L−R)′ attenuated in accordance with the frequency response of the first order LC bandpass filter BPF of FIG. 1 and showing at the 1 kHz center frequency fc of the bandpass filter BPF an attenuation of 0 dB with respect to mono, as illustrated with line curve v(mono).

The relation between 0 dB attenuation of the auxiliary difference signal (L−R)′ and the channel separation CHS=20 log L/R resulting therefrom in a stereo signal processing device SPD of FIG. 1 is indicated on the top row of the table of FIG. 1.

Curve −v[(right)−v(left)] shows the frequency dependent variation of the channel separation between the left and right reproduction signals expressed in 20 log L/R, in which for the left reproduction signal Lxs, the left input signal L of the auxiliary difference signal (L−R)′ is shown with curve v(left) and in which the right input signal R is shown with curve v(right).

Curve −v[(right)−v(left)] shows an upswing in channel separation exceeding 40 dB within a relatively small frequency range around fc in accordance with the invention, with a channel peak value exceeding 40 dB by far. A sensation of stereo reproduction is obtained for channel separation values exceeding 6 dB, i.e. for audio frequencies within the frequency range from approximately 300 Hz to 3 kHz (see exact frequencies in the signal plot of the FIG. 10).

FIG. 11 shows a signal plot illustrating the frequency dependent variations of the respective L- and R-input signals in the left reproduction signal Lxs=20 log L/S. At the center frequency fc the left reproduction signal Lxs corresponds to the left input signal L without any crosstalk from the right input signal R. A sensation of stereo reproduction is obtained for ratios of L/R exceeding approximately L/R=2.1(L=1.35; R=0.65), which correspond with channel separation values exceeding 6 dB.

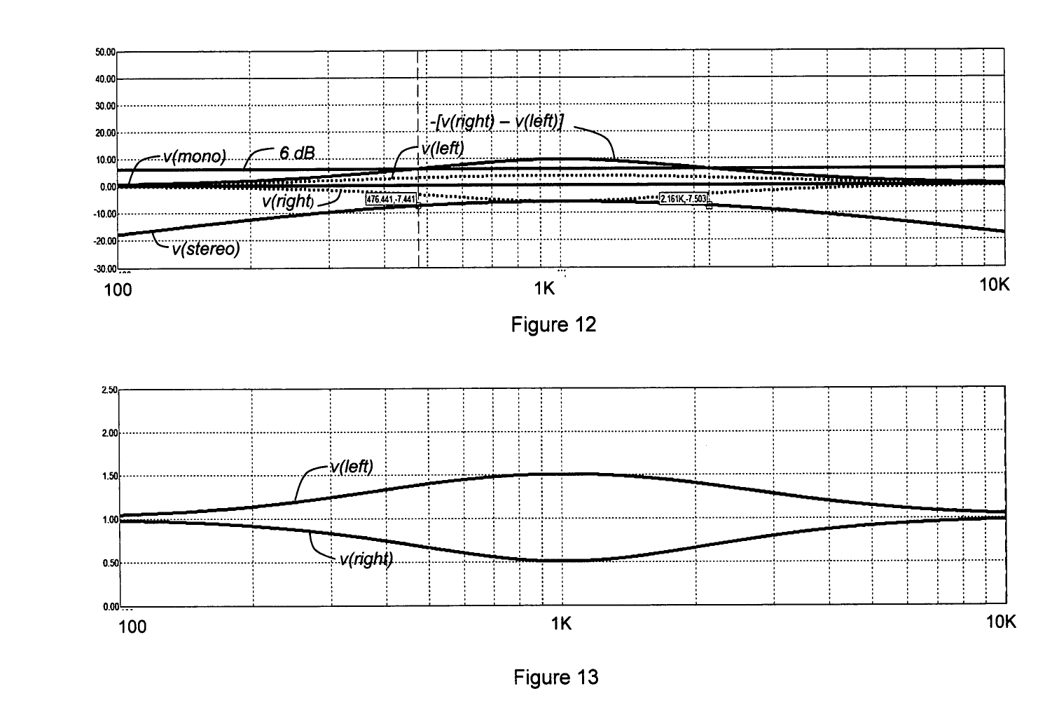

FIG. 12 shows the effect of a frequency independent 6 dB attenuation of the auxiliary difference signal (L−R)′ on the channel separation, which may be necessary e.g. to obtain a stronger noise reduction than in the situation of FIGS. 10 and 11. The channel peak value CHS=20 log L/R at fc is now decreased to approximately 10 dB and along therewith the sensation of stereo reproduction is decreased to the range of audio frequencies from approximately 500 Hz to 2 kHz.

FIG. 13 is in line with the FIG. 12, at those two boundary frequencies L=1.5 and R=0.5, i.e. L/R=3, defining said CHS of approximately 6 dB.

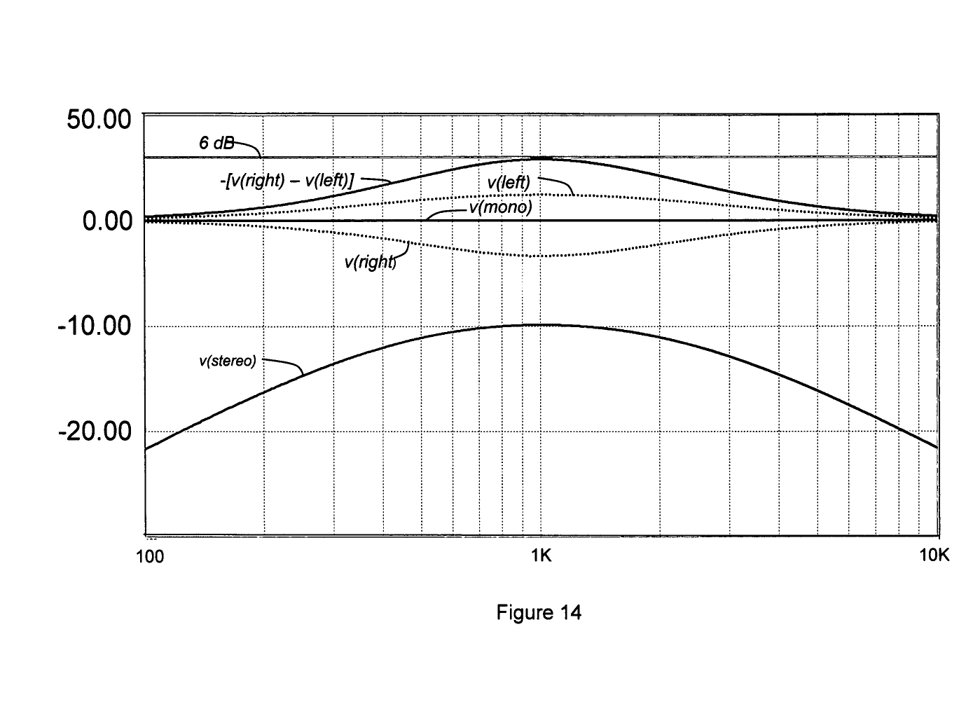

FIG. 14 shows the effect of a frequency independent 10 dB attenuation of the auxiliary difference signal (L−R)′ on the channel separation. The channel peak value CHS=20 log L/R at fc is now decreased to approximately 6 dB. This means that nowhere within the frequency range from 100 Hz to 10 kHz channel separation will exceed the minimum channel separation value of 6 dB sufficiently to arouse the sensation of stereo reproduction.

As both left and right reproduction signals Lxs and Rxs are mutually the above signal plots apply mutatis mutandis also the right reproduction signal Rxs.

Now, the present invention has hereabove been disclosed with reference to preferred embodiments thereof. The invention may be applied in analogue, digital and/or software related implementation. If implemented in digital or software related form, then an ADC circuit would be needed, preferably in the IF signal path preceding the FM demodulator FMD. Such digital implementation allows for filter designs, which may be more flexible in terms of frequency response/bandwidth.

The embodiments as shown and described hereabove, should be considered as being illustrative, and no restriction should be construed from those embodiments, other than as have been recited in the Claims.

Persons skilled in the art will recognize that numerous modifications and changes may be made to the embodiments shown without exceeding the scope of the appended Claims.

For instance:

The invention may well be applied without compensation for β related amplitude variations within the blending range.

An alternative embodiment of the FM receiver according to the invention may well be using a conventional FM fieldstrength and/or noise detector for directly or indirectly controlling the frequency response of the filter selectivity.

Another alternative embodiment of the FM receiver according to the invention may be using a tuning control signal generator TCSG, which includes a look-up table of weighting factors for weighting the RMS SNR of the (L−R) difference signal in accordance with the sensitivity of the human auditory system.

In yet another alternative embodiment of the FM receiver according to the invention, the signal and noise bandpass filters BPFS and BPFN are located around a resonance frequency within the upper half of the sensitivity range of the human auditory system.

The invention is not limited to the use thereof in FM receivers, but may well be used in general audio signal processors, such as DVD and MP3 players, Ipods, etc.

Throughout the specification, and/or in the claims, the expression “decreasing the bandwidth of said filter selectivity to a predetermined non-zero bandwidth without essentially varying said stereo channel separation peak value” is to disclaim wanted and/or actively initiated variations in the maximum channel separation occurring at the center frequency of the filter selectivity value and to avoid unwanted variations, due to e.g. parasitic phenomena and or environmental conditions from limiting the scope of the claims.

Furthermore the term “blending rate β” may be replaced by the term “weighting factor” as used in the above mentioned U.S. Pat. No. 7,715,567, to the extent that blending rate β=1 corresponds with weighting factor 0 and blending rate β=0 corresponds with weighting factor 1.

The term “coupled” means either a direct electrical connection between the things that are connected, or an indirect connection through one or more passive or active intermediary devices.

The term “circuit” means one or more passive and/or active components that are arranged to cooperate through digital or analogue signals with one another to provide a desired function. The term “signal” means at least one current signal, voltage signal, electromagnetic wave signal, or data signal. The meaning of “a”, “an”, and “the” include plural references. The meaning of “in” includes “in” and “on”.

1. A method for reducing noise included in a stereo reproduction signal derived from a stereo input signal comprising:
varying channel separation of the stereo reproduction signal with frequency within the frequency range of the stereo input signal in accordance with the frequency response of a filter selectivity located around a non-zero center frequency to obtain a channel separation peak value at the center frequency;
obtaining a measure of the noise; and
decreasing the bandwidth of the filter as the noise increases, the decreasing bandwidth being limited to a predetermined non-zero bandwidth.

2. The method of claim 1 wherein the channel separation of the stereo reproduction signal at the center frequency of the filter selectivity within the range of the filter selectivity bandwidth variation is at least 6 dB.

3. The method of claim 1 wherein the filter provides an auxiliary signal from the stereo input signal, the auxiliary signal being combined with left and right input signals of the stereo input signal to obtain left and right reproduction signals of the stereo reproduction signal.

4. The method of claim 3 wherein the stereo input signal corresponds to a stereo multiplex signal comprising (L+R) sum and (L−R) difference signals of left and right input signals, L and R, respectively, and the filter includes a bandpass filter that provides an auxiliary difference signal (L−R)′ from the stereo difference signal (L−R); and the method includes demultiplexing the sum signal (L+R) with the auxiliary difference signal (L−R)′ to obtain the left and right reproduction signals.

5. The method of claim 4, including:
deriving, via at least one bandstop filter, auxiliary left and right signals, L′ and R′, from the left and right input signals L and R, respectively;
summing the left input signal L and the auxiliary right signal R′ to obtain the left reproduction signal; and
summing the right signal R and the auxiliary left signal L′ to obtain the right reproduction signal.

6. The method of claim 4, including:
measuring an RMS SNR ratio of the auxiliary difference signal (L−R)′; and
varying the bandwidth of the filter selectivity in response to the RMS SNR.

7. A stereo signal processing device for reducing noise included in a stereo reproduction signal derived from a stereo input signal, including:
first and second channels receiving respectively first and second signal components of the stereo input signal,
at least one filter located around a non-zero center frequency and coupled to at least one of the first and second stereo channels, a channel separation of the stereo reproduction signal being defined by a frequency response of the filter, with a channel separation peak value at the center frequency, and
an SNR detector that generates a bandwidth control signal that varies with an SNR of at least part of the stereo input signal, the bandwidth control signal decreasing the bandwidth of the filter as the SNR decreases, and vice versa, the decreasing bandwidth being limited to a predetermined non-zero value.

8. The stereo signal processing device of claim 7, wherein the channel separation of the stereo reproduction signal at the center frequency is at least 6 dB.

9. The stereo signal processing device of claim 8, wherein the filter provides an auxiliary signal from the stereo input signal, the auxiliary signal being combined with left and right input signals of the stereo input signal to obtain left and right reproduction signals of the stereo reproduction signal.

10. The stereo signal processing device of claim 7, wherein the first and second stereo channels respectively receive sum and difference signals (L+R) and (L−R) of a stereo multiplex signal, the first stereo channel being coupled to first inputs of a demultiplexer, the filter including a bandwidth controllable bandpass filter coupled to the second stereo channel and configured to provide from the difference signal (L−R) an auxiliary difference signal (L−R)′, the auxiliary difference signal (L−R)′ being supplied to second inputs of the demultiplexer to demultiplex the sum signal (L+R) with the auxiliary difference signal (L−R)′ into the left and right reproduction signals.

11. The stereo signal processing device of claim 7, wherein the first and second stereo channels receive left and right input signals L and R, respectively, of a stereo input signal, the first and second stereo channels being coupled to first inputs of respectively, first and second summing stages, and to respectively, left and right bandwidth controllable bandstop filters included in the at least one filter, and configured to provide auxiliary left and right signals L′ and R′, respectively, from the respective left and right input signals, L and R, respectively, the auxiliary left and right signals, L′ and R′, respectively, being supplied to second inputs of respectively the second and first summing stages to provide respectively, the left and right reproduction signals.

12. The stereo signal processing device of claim 10, wherein the SNR detector measures an RMS SNR of the auxiliary (L−R) difference signal.

13. The stereo signal processing device of claim 12, wherein the SNR detector is configured to receive an RMS SNR set level and generate a bandwidth control signal depending on a difference between the RMS SNR and the RMS SNR set level, the bandwidth control signal being supplied as a negative feedback of the difference.

14. The stereo signal processing device of claim 7, wherein the SNR detector includes a spectrum analyzer that measures an RMS SNR of a difference signal (L−R) between left and right input signals, L and R, respectively, of the stereo input signal, and is coupled to a tuning control signal generator that is configured to determine the center frequency, the center frequency being based on a center frequence fcw of a frequency window with bandwidth Δfw covering an audio frequency range within a frequency range of the (L−R) difference signal with an RMS SNR that is maximal relative to the bandwidth Δfw, and to derive from the center frequency fcw, tuning data that is supplied to the filter to vary its center frequency to the center frequency fcw of the frequency window.

15. The stereo signal processing device of claim 14, wherein the tuning control signal generator includes a table of weighting factors for weighting the RMS SNR of the difference signal (L−R) in accordance with the sensitivity of the human auditory system, and is configured to receive the bandwidth control signal to vary the bandwidth Δfw of the frequency window in correspondence with the bandwidth of the filter, as well as a threshold value limiting its tuning control range to a bandwidth control range of the filter decreasing below the predetermined non-zero value.

16. The stereo signal processing device of claim 7, including an FM receiver comprising an RF/IF front end that converts an RF FM stereo signal into the stereo input signal.

17. The stereo signal processing device of claim 16, wherein the SNR detector includes a fieldstrength detector that provides the bandwidth control signal based on a fieldstrength of an RF FM reception signal.

18. The stereo signal processing device of claim 17, including a control signal generator that is coupled between the fieldstrength detector and the filter and includes a look-up table comprising a number of set values including bandwidth and/or tuning data for the filter allocated to various levels of fieldstrength of the RF FM reception signal, the control signal generator being configured to supply at a predetermined level of the fieldstrength, bandwidth and/or tuning data allocated to the predetermined level to the filter for controlling the bandwidth and tuning of the center frequency.

19. The stereo signal processing device of claim 16 including a control signal generator that is coupled between the SNR detector and the filter and includes a look-up table comprising a number of set values including bandwidth and/or tuning data for the filter allocated to various levels of SNR of the RF FM reception signal, the control signal generator being configured to supply at a predetermined level of the SNR, bandwidth and/or tuning data allocated to the predetermined level to the filter for controlling the bandwidth and tuning of the center frequency.

20. The method of claim 2, wherein the filter provides an auxiliary signal from the stereo input signal, the auxiliary signal being combined with left and right input signals of the stereo input signal to obtain left and right reproduction signals of the stereo reproduction signal.
